(19) United States
(12) Patent Application Publication
(10) Pub. No.: US 2008/0041900 A1
(43) Pub. Date: Feb. 21, 2008

(54) Wheelchair umbrella holster

(76) Inventor: Francis Leifermann, Huntington Beach, CA (US)

Correspondence Address: Karl M. Steins;Steins & Associates, Suite 120, 2333 Camino del Rio South, San Diego, CA, 92108, US

(21) Appl. No.: 11/505,792

(22) Filed: Aug. 16, 2006

(51) Int. Cl. A45B 11/02; A45F 5/00; B60R 7/00

(52) U.S. Cl. 224/407; 224/186; 224/251

(57) ABSTRACT

A Wheelchair Umbrella Holster is disclosed. The invention can be either an attachment to a legacy wheelchair, or incorporated as original equipment into a wheelchair of virtually any style. The holster has an elongate tube secured to the wheelchair such that it extends upwardly and has an open upper mouth. The upper mouth is configured to accept the handle of an umbrella therein. The holster should also have an open mouth at its lower end to prevent the accumulation of water, dirt or other materials in the bottom of the holster. The holster may be attached to the wheelchair with a plurality of cable ties or other lashing devices. Finally, the holster tube will be bisected by a stop member passing through the inner void within the tube to prevent the umbrella handle from dropping down into the lower chamber inside the holster's tube.

### BACKGROUND OF THE INVENTION

1. Field of the Invention

This invention relates generally to tamper-proof seals for containers and, more specifically, to a Wheelchair Umbrella Holster.

2. Description of Related Art

Confinement or periodic use of a wheelchair is an unfortunate aspect of life to be looked forward to for many of the elderly. While needing a wheelchair is certainly inconvenient, it does not have to be the end of the person's active lifestyle. Of course, there are some obstacles to deal with in order to experience this enjoyment. One problem in particular is the need for a sun and/or weather shade while outdoors. Historically, a wheelchair-bound individual either had to: (a) hold on to an umbrella themselves, or (b) ask an aide to carry the umbrella. Neither of these options are desirable—option (a) can be difficult or impossible for the wheelchair-bound individual to handle. Furthermore, it occupies at least one of the person's hands, making it challenging for the person to do anything else. Option (b) is also not desirable for essentially the same reason.

What is needed, then, is a sunshading or weather-protecting umbrella that can be attached to a conventional wheelchair so that the umbrella will be held to the wheelchair without the need for user or aide intervention.

### SUMMARY OF THE INVENTION

In light of the aforementioned problems associated with the prior devices and combinations, it is an object of the present invention to provide a Wheelchair Umbrella Holster. The invention should either be an attachment to a legacy wheelchair, or incorporated as original equipment into a wheelchair of virtually any style. The holster should have an elongate tube secured to the wheelchair such that it extends upwardly and has an open upper mouth. The upper mouth of the holster's tube should be configured to accept the handle of an umbrella therein. The holster may also have an open mouth at its lower end to prevent the accumulation of water, dirt or other materials in the bottom of the holster. The holster may be attachable to the wheelchair with a plurality of cable ties or other lashing devices. Finally, the holster tube should be bisected by a stop member passing through the inner void within the tube to prevent the umbrella handle from dropping down into the lower chamber inside the holster's tube.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a perspective view of a conventional wheelchair having an umbrella inserted into a preferred embodiment of the holster of the present invention;

FIG. 2 is a perspective view of the holster of FIG. 1;

FIG. 3 is a cutaway side view of the holster of FIGS. 1 and 2; and

FIG. 4 is a cutaway side view of the holster of FIGS. 1-3 having an umbrella inserted therein.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Wheelchair Umbrella Holster.

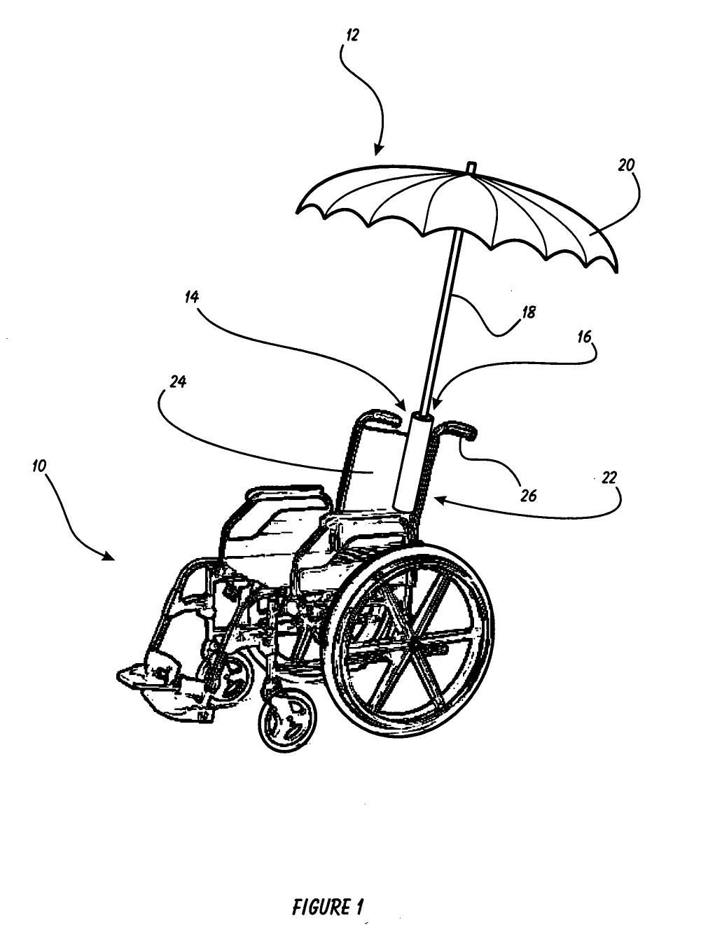

The present invention can best be understood by initial consideration of FIG. 1. FIG. 1 is a perspective view of a conventional wheelchair having an umbrella inserted into a preferred embodiment of the holster of the present invention. The umbrella holster 14 is preferably attached to the seatback frame member 22 of a conventional wheelchair 10. The seatback members 22 are the tubular sides to which the seat back 24 (canvas, cloth or other flexible material) attaches. The seatback members 22 typically extend from the seat bottom frame area upwardly until they terminate in the push handles 26 on each side. If the holster 14 is attached in the position shown, the holster 14 will be convenient for use, but will not cause discomfort for the wheelchair rider or his or her aide in grasping the push handle 26. While a conventional push-type wheelchair is depicted here, it is expected that the holster 14 of the present invention will be available in configurations that will be attachable to powered wheelchairs as well as the other conventional wheelchair designs available. Furthermore, the holster 14 may be incorporated into the wheelchair by the original equipment manufacturer (rather than being an attachment to a legacy wheelchair).

The umbrella handle 16 is inserted into the holster 14 so that the pole 18 extends upwardly to hold the head 20 of the umbrella over the head and body of the individual sitting in the chair 10.

In this drawing figure, the umbrella 12 is of the type used for golfing—golf umbrellas typically have the largest head 20 of any handheld umbrella, and therefore this drawing demonstrates that the holster 14 holds even the largest umbrellas securely to the wheelchair 10.

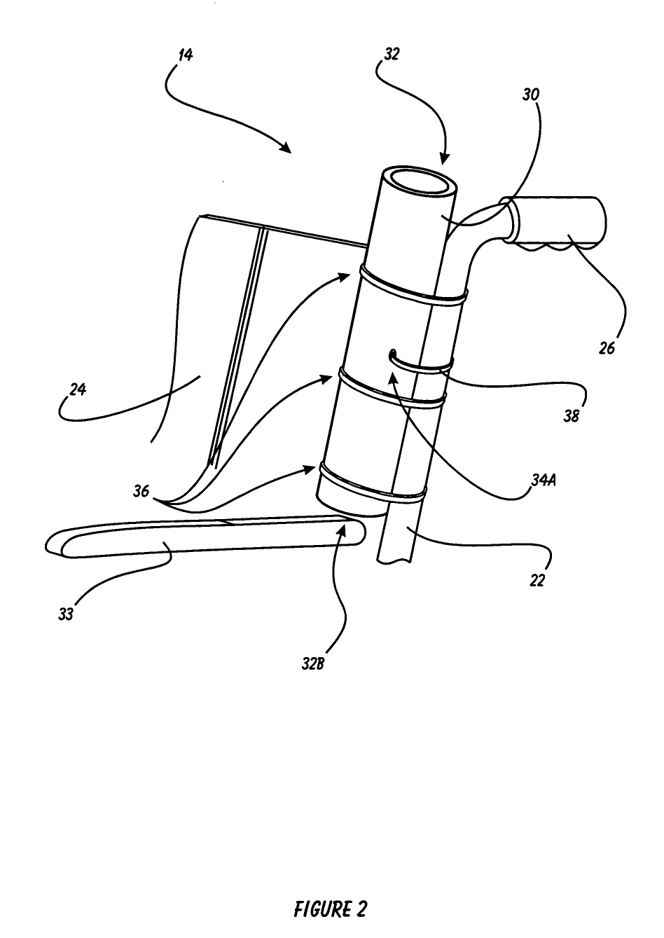

This wheelchair 10 is of the conventional folding variety, which is the most prevalent type being used today. The holster 14 is designed to allow the wheelchair 10 to be folded without the need for removing the holster 14. As a result of this, an umbrella 12 can be inserted into the holster 14 immediately upon arrival at the destination. If we now turn to FIG. 2, we can continue to examine the details of this invention.

FIG. 2 is a perspective view of the holster 14 of FIG. 1. The holster 14 has a retaining tube 30 terminating in an open top end 32A and an open bottom end 32B. In fact, the preferred tube 30 is simply a section of plastic piping with its ends being the top and bottom ends 32A and 32B. The tube 30 is attached to the seatback frame member 22 by two or more retaining straps 36. These retaining straps 36 could be clamps, wires, ropes, etc., but the preferred version is to use electrical “cable ties” because cable ties are durable, plastic straps that self-secure once they are pulled taut. In the typical installation, the bottom end 32B of the holster 14 rests atop the arm rest 33, but it is not an installation requirement.

The tube 30 preferably has a pair of stop apertures (the first stop aperture 34A shown here). A stop strap 38 is preferably threaded through these apertures 34. The stop strap 38 closes off the bottom of the tube 30 approximately half way down the length of the tube 30. The stop strap 38 prevents the umbrella handle from sliding too far down into the tube 30, and holds the handle in a convenient location for removal, when desired.

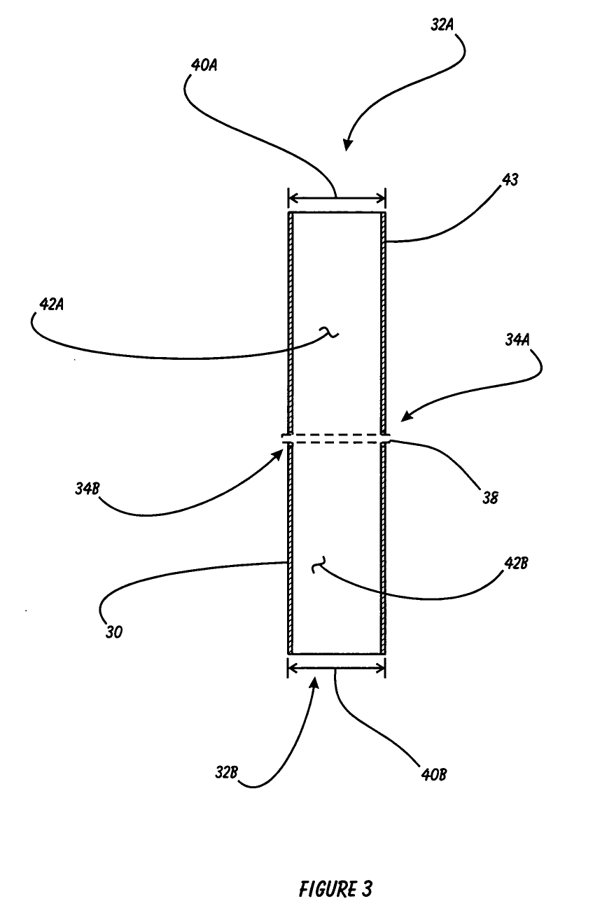

The benefit, besides cost advantages, of the holster 14 tube 30 is formed from a piece of pipe to allow for rain and other environmental contaminants to drop out of the bottom of the tube 30, rather than accumulating and cluttering up the holster 14. Turning to FIG. 3, we can examine additional details regarding this invention.

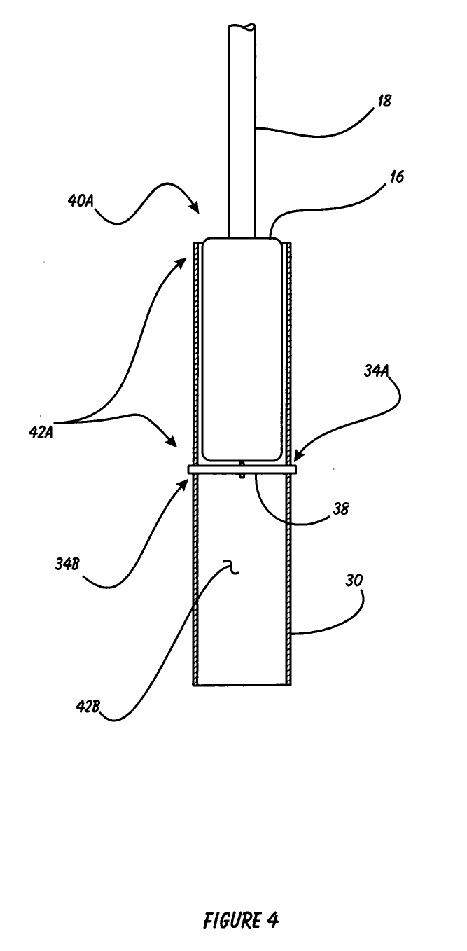

FIG. 3 is a cutaway side view of the holster 14 of FIGS. 1 and 2. The retaining tube 30 has a generally circular wall 43 extending from the upper mouth 40A, located at the top end 32A, to the lower mouth 40B, located at the bottom end 32B. In this version, there is a first stop aperture 34A and a second stop aperture 34B formed in the wall 43 generally across from one another approximately midway down the length of the tube 30. The stop strap 38 bisects the inside volume of the tube 30 into a handle cavity portion 42A at the top of the tube 30, and a lower cavity portion 42B at the bottom of the tube 30. As discussed above, since the stop strap 38 (which can comprise a variety of members/types, but preferably is another cable tie) doesn't actually block the tube 30, water and other intruding materials will simply pass out through the lower mouth 40B of the tube 30. Finally turning to FIG. 4, we can examine how the stop strap 38 operates.

FIG. 4 is a cutaway side view of the holster 14 of FIGS. 1-3 having an umbrella inserted therein. As shown, the tube 30 is sized large enough so that the umbrella handle 16 can be easily inserted and removed, but also small enough so that the handle 16 doesn't rattle around in the tube 30 (and therefore the umbrella is held securely upright).

Also shown here is the stop strap 38, and how it prevents the handle 16 from sliding down too far into the tube 30. If a different umbrella is acquired that perhaps has a handle 16 that is either longer or shorter than that shown here, a new pair of stop apertures 34A and 34B can be cut at a new location along the height of the tube 30.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A combination umbrella and holster therefor, comprising:
an umbrella, comprising a handle, a post extending upwardly from said handle and terminating in a head; and
a holster, comprising:
an elongate retaining tube defined by a substantially open top end and a substantially open bottom end opposing said top end and an inner cavity formed within said tube; and
a stop member dividing said inner cavity into a handle cavity portion and a lower cavity portion.

2. The combination of claim 1, wherein:
said retaining tube comprises a generally cylindrical wall terminating at said top and bottom ends;
a pair of stop apertures formed in said wall on opposite sides of said inner cavity; and
said stop member passes through said stop apertures.

3. The combination of claim 2, wherein said stop member comprises a strap encircling a portion of said tube and passing through said stop apertures.

4. The combination of claim 3, wherein said holster further comprises attachment means for attaching said holster to an external tubular member.

5. The combination of claim 4, wherein said attachment means comprises a plurality of cable ties encircling said retaining tube and said external tubular member.

6. A wheelchair, comprising:
a frame comprising a pair of seatback frame members;
at least two transport wheels associated with said frame; and
an umbrella holster attached to said frame, said holster comprising:
an elongate retaining tube defmed by a substantially open top end and a substantially open bottom end opposing said top end and an inner cavity formed within said tube; and
a stop member dividing said inner cavity into a handle cavity portion and a lower cavity portion.

7. The wheelchair of claim 6, wherein:
said retaining tube comprises a generally cylindrical wall terminating at said top and bottom ends, with an open mouth at each said end;
a pair of stop apertures formed in said wall on opposite sides of said inner cavity; and
said stop member passes through said stop apertures.

8. The wheelchair of claim 7, wherein said stop member comprises a strap encircling a portion of said tube and passing through said stop apertures.

9. The wheelchair of claim 8, wherein said holster further comprises attachment means for attaching said holster to a said seatback frame member.

10. The wheelchair of claim 9, wherein said attachment means comprises a plurality of cable ties encircling said retaining tube and said seatback frame member.

11. An umbrella holster, comprising:
an elongate tube having a generally cylindrical wall defining an open top end, an open bottom end, and an interior void; and
stop means for stopping an object inserted into an end from sliding through said tube, said stop means intruding into said interior void between a handle cavity portion of said void and a lower cavity portion of said void.

12. The holster of claim 11, comprising:
a pair of stop apertures formed in said wall on opposite sides of said inner void; and
said stop means passes through said stop apertures.

13. The holster of claim 12, wherein said stop means comprises a strap encircling a portion of said tube and passing through said stop apertures.

14. The holster of claim 13, wherein said holster further comprises attachment means for attaching said holster to an external tubular member.

15. The holster of claim 14, wherein said attachment means comprises a plurality of cable ties encircling said retaining tube and said external tubular member.
